(19) United States
(12) Patent Application Publication
(10) Pub. No.: US 2025/0254420 A1
(43) Pub. Date: Aug. 7, 2025

(54) ACCESSORY APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: TATSUO TAKATORI, Tokyo (JP)

(21) Appl. No.: 19/025,382

(22) Filed: Jan. 16, 2025

(30) Foreign Application Priority Data
Feb. 6, 2024 (JP) 2024-016230

(51) Int. Cl. H04N 23/663; G03B 17/56

(52) U.S. Cl. CPC H04N 23/663; G03B 17/56

(57) ABSTRACT

An accessory apparatus is attachable to and detachable from an image pickup apparatus. The accessory apparatus includes an accessory processor configured to acquire a first set value for the accessory apparatus stored in the image pickup apparatus through communication with the image pickup apparatus, and an accessory memory storing a second set value for the accessory apparatus. The accessory processor is configured to determine whether to preferentially use the first set value or the second set value as a set value for the accessory apparatus according to a user setting.

### BACKGROUND

### Technical Field

The present disclosure relates to an accessory apparatus, an image pickup apparatus, a control method, and a storage medium.

### Description of Related Art

Japanese Patent Laid-Open No. 2009-31462 discloses an image pickup apparatus that can set a set value for an external flash (or strobe) apparatus, and includes a memory storing the set value for the external flash apparatus, and a control unit configured to clear the set value in a case where an attachment change of the external flash apparatus is detected.

In a case where a different external flash apparatus is attached, the image pickup apparatus disclosed in Japanese Patent Laid-Open No. 2009-31462 is to set the set value for the external flash apparatus again. For example, a plurality of types of external flash apparatus may have settable functions and set values that are different from each other. In addition, a user who wishes to use the set value originally set for a certain external flash apparatus for another external flash apparatus as well, reset the setting in a case where the set value is changed unintentionally. Therefore, user convenience deteriorates.

### SUMMARY

An accessory apparatus according to one aspect of the disclosure is attachable to and detachable from an image pickup apparatus. The accessory apparatus includes an accessory processor configured to acquire a first set value for the accessory apparatus stored in the image pickup apparatus through communication with the image pickup apparatus, and an accessory memory storing a second set value for the accessory apparatus. The accessory processor is configured to determine whether to preferentially use the first set value or the second set value as a set value for the accessory apparatus according to a user setting. A control method of the above accessory apparatus also constitutes another aspect of the disclosure. A storage medium storing a program that causes a computer to execute the above control method also constitutes another aspect of the disclosure.

An image pickup apparatus according to another aspect of the disclosure is attachable to and detachable from an accessory apparatus. The image pickup apparatus includes a camera memory storing a first set value for the accessory apparatus, and a camera processor configured to transmit the first set value to the accessory apparatus through communication with the accessory apparatus, and determine whether to preferentially use the first set value or a second set value stored in the accessory apparatus as a set value for the accessory apparatus according to a user setting. A control method of the above image pickup apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an imaging system according to each embodiment.

FIG. 2 illustrates an example screen in performing a setting change of an accessory apparatus in an image pickup apparatus.

FIGS. 3A, 3B, and 3C illustrate example set values in a case where different accessory apparatuses are attached to the image pickup apparatus.

FIG. 4 is a flowchart illustrating setting processing for an accessory apparatus according to a first embodiment.

FIG. 5 illustrates an example setting screen for accessory settings in the first embodiment.

FIG. 6 illustrates example setting items and set value information in first accessory setting information in the first embodiment.

FIGS. 7A and 7B illustrate an example of a first accessory set value in the first embodiment and set values that can be set for the accessory apparatus.

FIG. 8 is a flowchart illustrating setting processing for an accessory apparatus according to a second embodiment.

FIGS. 9A, 9B, 9C, and 9D illustrate examples of accessory function setting screens displayed on an image pickup apparatus according to the second embodiment.

FIG. 10 is a flowchart illustrating setting processing for an accessory apparatus according to a third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

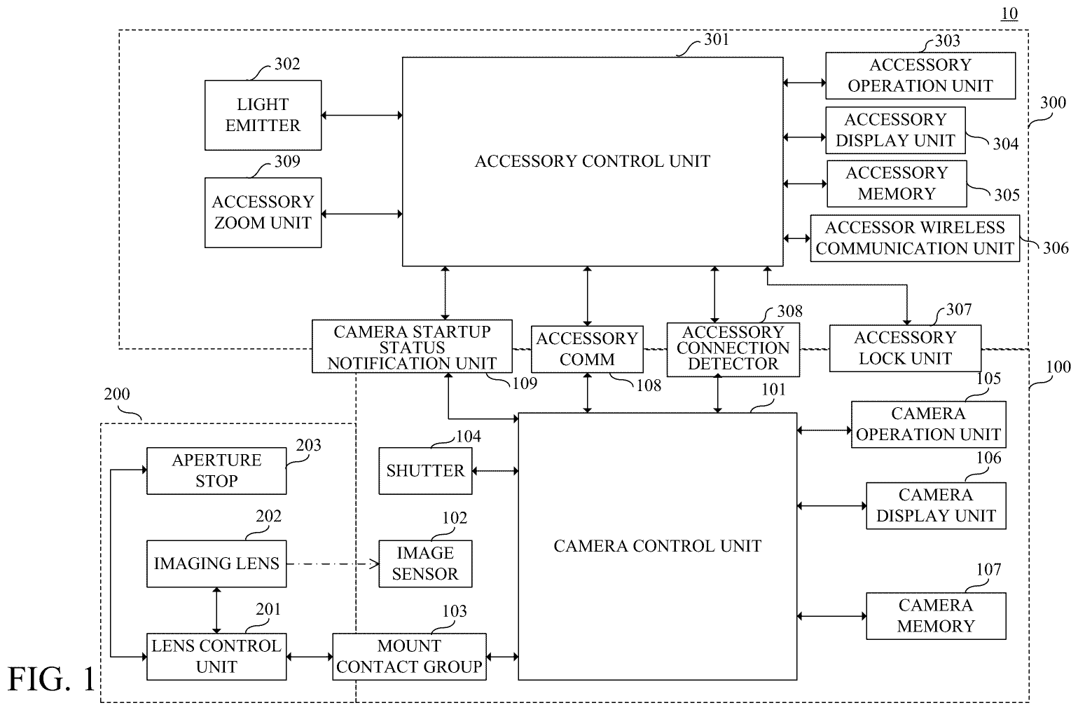

Referring now to FIG. 1, a description will be given of an imaging system

10 according to each embodiment. FIG. 1 is a block diagram of the imaging system 10. The imaging system 10 includes a camera body (image pickup apparatus) 100, a lens apparatus (interchangeable lens) 200, and an accessory apparatus (illumination apparatus) 300.

The camera body 100 and the lens apparatus 200 are mechanically and electrically connected via a mount contact group 103. In each embodiment, the lens apparatus 200 is attachable to and detachable from the camera body 100, but is not limited to this example, and may be integrated with the camera body 100. The accessory apparatus 300 is attachable to and detachable from a top surface of the camera body 100. In each embodiment, the accessory apparatus 300 is a flash apparatus (illumination apparatus), but is not limited to this example. The accessory apparatus 300 may be another apparatus such as a microphone, a video light, or a transmitter, as long as it is connectible to the camera body 100.

The camera body 100 and the accessory apparatus 300 are interchangeable. The camera body 100 and the accessory apparatus 300 are electrically connected via an accessory communication unit 108, a camera startup status notification unit 109, and an accessory connection detector 308. The camera body 100 and the accessory apparatus 300 can be fixed by setting an accessory lock unit 307 to a lock position.

The camera control unit 101 is a microcomputer (camera processor) that controls the operation of each component in the camera body 100. An image sensor 102 is a photoelectric conversion element such as a Complementary Metal-Oxide-Semiconductor (CMOS) sensor or a Charge Coupled Device (CCD) sensor. The image sensor 102 may include an infrared cut filter and a low-pass filter.

A shutter 104 is disposed between the image sensor 102 and the lens apparatus 200. The shutter 104 closes to shield light from the image sensor 102 during non-imaging, and opens during live-view or imaging, directing incident light that has passed through the lens apparatus 200 to the image sensor 102, according to an instruction from the camera control unit 101.

A camera operation unit 105 includes an operation member operable by the user, detects an operation performed by the user via a button, a switch, a dial, and a connected device attached to the camera body 100, and transmits a signal according to the operation instruction to the camera control unit 101. The camera operation unit 105 outputs to the camera control unit 101 an instruction signal (SW1 signal) issued in a case where the user half-presses a release button, and an instruction signal (SW2 signal) issued in a case where the user fully presses the release button.

A camera display unit 106 displays imaging information, a captured image, and a camera setting menu according to an instruction from the camera control unit 101. The user operates the camera operation unit 105 to change a set value for the camera body 100 from a camera setting menu displayed on the camera display unit 106. At this time, the camera control unit 101 performs processing of writing a set value for the camera body 100 to the camera memory 107. In each embodiment, the information stored in the camera memory 107 includes, but is not limited to, setting information regarding the accessory apparatus 300, a set value and adjustment value for the camera body 100, etc.

The camera control unit 101 controls the operation of the camera body 100 based on the output signal of the camera operation unit 105. In a case where the output signal of the camera operation unit 105 is the SW1 signal, the camera control unit 101 drives the image sensor 102 to capture an image, and repeats photometry control to measure the luminance of an object from the captured image result. The camera control unit 101 also determines a shutter speed, an aperture value (F-number), and ISO sensitivity (ISO speed) to be used for imaging from the photometry result. Here, the shutter speed, aperture value, and ISO sensitivity to be used for imaging are collectively referred to as exposure control values. The exposure control values determined by the camera control unit 101 are displayed on the screen of the camera display unit 106. In a case where the output signal of the camera operation unit 105 is the SW2 signal, the aperture stop (diaphragm) 203 in the lens apparatus 200 is driven, the sensitivity (ISO sensitivity) of the image sensor 102 is set, and the shutter 104 is controlled to irradiate the image sensor 102 with light.

The camera control unit 101 displays a captured image on the screen of the camera display unit 106 according to image data acquired from the image sensor 102, and also performs processing to write the image data to the camera memory 107. The camera control unit 101 notifies the accessory apparatus 300 of the camera state via the camera startup status notification unit 109 according to the camera power supply state. For example, in a case where the output signal of the camera operation unit 105 is a power SW off signal, the camera control unit 101 cuts off the power supply. Accordingly, the signal level of the camera startup status notification unit 109 becomes low, and the accessory apparatus 300 detects that the power status of the camera body 100 has been turned off.

The configuration of the lens apparatus 200 will now be described. The lens control unit 201 is a microcomputer (lens processor) that controls the operation of each component in the lens apparatus 200. The imaging lens 202 includes a plurality of lenses, and forms an object image on the image sensor 102. The lens apparatus 200 (imaging lens 202) includes an aperture stop 203 configured to adjust a light amount, and a focus lens (not illustrated) for focusing. The lens control unit 201 adjusts a light amount taken into the camera body 100 and a focus state according to instructions from the camera control unit 101, under control via the mount contact group 103.

The configuration of the accessory apparatus 300 will now be described. An accessory control unit 301 is a microcomputer (accessory processor) configured to control the operation of each component in the accessory apparatus 300. The accessory control unit 301 can communicate with the camera control unit 101 via the accessory communication unit 108, and can receive light emission control instructions and camera information from the camera control unit 101 and transmit accessory information. The communication method may have a plurality of communications (such as one of which is a high-rate communication and the other of which is a low-rate communication). For example, the communication method may be divided into a CPU that manages the power limit of the camera body 100 and the state change signal of the accessory apparatus 300, and a CPU that mainly controls imaging of the camera body 100.

A light emitter 302 includes a discharge tube, a light emitting capacitor, a light emitting circuit, and a light emitting optical system, and can emit flash light. An accessory operation unit 303 includes members operable by the user, detects the operation performed by the user via a button, dial, or switch attached to the accessory apparatus 300, and sends a signal according to the operation instruction to the accessory control unit 301.

An accessory display unit 304 displays the light emission setting, the radio wave setting, the operation state of the accessory according to the instruction of the accessory control unit 301, etc. An accessory memory 305 is a nonvolatile memory electrically connected to the accessory control unit 301, and the accessory control unit 301 sets the accessory memory 305 via serial communication. The information stored in the accessory memory 305 in this embodiment includes, but is not limited to, control information, setting information, and adjustment values for the accessory apparatus 300.

An accessory wireless communication unit 306 transmits and receives wireless communication information to and from the accessory apparatus 300 that is wirelessly connected via a wireless antenna (not illustrated). The accessory control unit 301 can transmit and receive control information to other accessory apparatuses that are wirelessly connected via the accessory wireless communication unit 306.

An accessory lock unit 307 is a member for fixing the accessory apparatus 300 to an accessory shoe unit (not illustrated) of the camera body 100. By moving the accessory lock unit 307 to a predetermined position, the accessory apparatus 300 and the camera body 100 can be fixed together.

An accessory connection detector 308 outputs an accessory detecting signal to the camera control unit 101 in a case where the accessory lock unit 307 moves to a lock or unlocked position. Thereby, the camera control unit 101 can detect a connection state. The accessory lock unit 307 and the accessory connection detector 308 may be electrically connected to output a signal in conjunction with the accessory lock unit 307. The accessory control unit 301 may obtain an output signal from the accessory connection detector 308 by detecting a SW state of the accessory lock unit 307.

An accessory zoom unit 309 can change an irradiation angle during light emission by driving a motor provided in the accessory zoom unit 309 based on a pulsed signal output by the accessory control unit 301. The user can change the setting of the irradiation angle by operating the accessory operation unit 303. Alternatively, the camera control unit 101 may obtain a focal length of the lens from the lens control unit 201 and notify the accessory control unit 301 via the accessory communication unit 108, thereby changing the setting of the irradiation angle.

Generally, flash photography (strobe photographing) is used in various scenes, such as backlit scenes in the daytime or in the dark, where a flash is aimed at an object, and wireless multi-light flash photography, where a plurality of strobes are used to create an image by emitting light beams. For photographic expression in various scenes, a user performs imaging by changing various set values of the external flash apparatus, such as the wireless multi-flash setting, synchronization setting, and light regulation control.

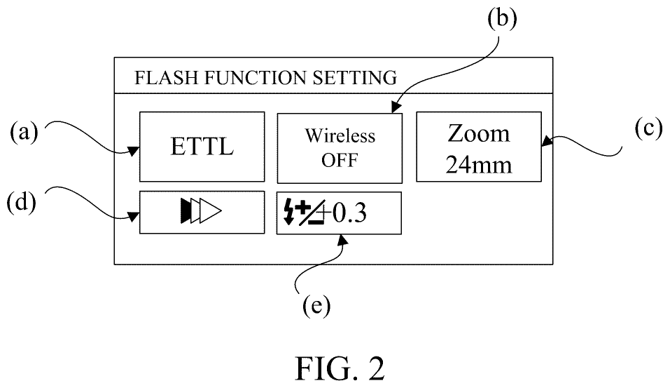

FIG. 2 is an example menu screen for changing the setting for the external flash apparatus in the image pickup apparatus. For example, a user can operate the image pickup apparatus while the external flash apparatus is attached to the image pickup apparatus, so that the user displays an external flash function setting screen as illustrated in FIG. 2, selects a function of the external flash apparatus, and changes the setting. Examples of the functions of the external flash apparatus whose setting can be changed include a light emission mode (a), a wireless setting (b), an irradiation angle setting (c), a synchronization setting (d), and a light regulation control value (e). Other settings may be displayed and can be set. In addition to the above method, a user can change the setting by operating the external flash apparatus body having a display member and an operating member.

A user may have a plurality of external flash apparatuses, and may detach the current external flash apparatus attached to the image pickup apparatus and attach a different external flash apparatus for imaging. Thus, the set value may not be changed even in a case where such a different external flash apparatus is attached to the image pickup apparatus.

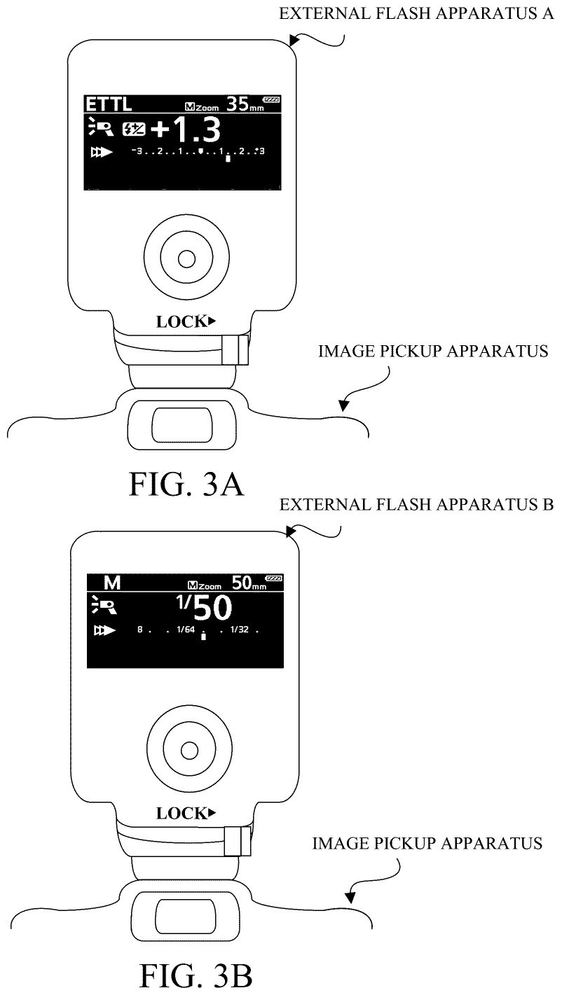

FIGS. 3A and 3B illustrate an example of two external flash apparatuses with different settings. Each of external flash apparatuses A (FIG. 3A) and B (FIG. 3B) have different set values for light emission mode, irradiation angle, light regulation control, or light emitting amount. t. In the example using these external flash apparatuses, in the method disclosed in Japanese Patent Laid-Open No. 2009-31462, in a case where the image pickup apparatus is attached to the external flash apparatus A, the image pickup apparatus obtains the set value from the external flash apparatus A using a communication unit and stores the set value in the memory in the image pickup apparatus. In a case where the image pickup apparatus detects that the external flash apparatus A has been disconnected using the connection detector configured to detect the connection, the image pickup apparatus clears the set value for the external flash apparatus A.

In a case where a user replaces the external flash apparatus A with the external flash apparatus B and intends to perform imaging using the settings of the external flash apparatus A, the user needs to reset the settings of the external flash apparatus A to the external flash apparatus B. This is inconvenient for a user who wishes to perform imaging using the same settings for the external flash apparatuses A and B.

Accordingly, the settings of the external flash apparatus A connected to the image pickup apparatus in FIG. 3A may be maintained in the image pickup apparatus, and in a case where the external flash apparatus B is attached to the image pickup apparatus, the settings may be the same as those of the external flash apparatus A as illustrated in FIG. 3C. Thus, for example, the image pickup apparatus acquires and maintains setting information regarding the external flash function from the attached external flash apparatus A using a communication unit, and notifies the external flash apparatus B of the setting information in a case where the external flash apparatus B is attached. The external flash apparatus B then resets the notified setting information as its own setting information.

Each embodiment will be described below in detail.

### First Embodiment

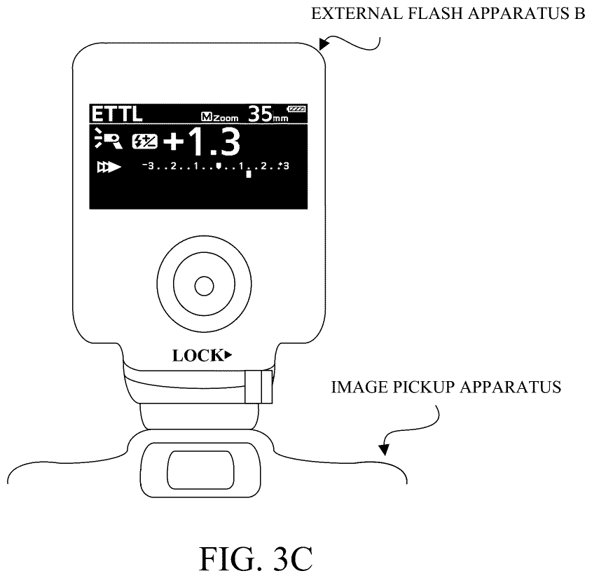

Referring now to FIG. 4, a description will now be given of setting processing for the accessory apparatus 300 according to a first embodiment. FIG. 4 is a flowchart illustrating the setting processing for the accessory apparatus 300 according to this embodiment. Each step in FIG. 4 is mainly executed by the camera control unit 101 or the accessory control unit 301. This embodiment will describe a method for reflecting set values (accessory function settings) for the accessory apparatus held by the camera body 100 in the accessory apparatus 300 in a case where the user attaches the accessory apparatus 300 to the camera body 100.

First, in step S401, the accessory control unit 301 detects a connection with the camera body 100 by monitoring the accessory connection detector 308 or the camera startup status notification unit 109, and determines whether or not the camera connection status has changed (whether or not there is a connection detection). In this determination, in a case where it is determined that the camera connection status has changed (there is a connection detection with the camera body 100), the flow proceeds to step S402. On the other hand, in a case where the camera connection status has not changed, the accessory control unit 301 continues to monitor the accessory connection detector 308 or the camera startup status notification unit 109.

In step S402, the accessory control unit 301 performs processing required to establish a connection status with the camera body 100 (connection processing). Here, the connection processing may be started in a case where the power levels of the terminals attached to the camera body 100 and the accessory apparatus 300 exceed specified values, or the connection processing may be started according to a connection protocol via the accessory communication unit 108.

Next, in step S403, the camera control unit 101 or the accessory control unit 301 determines the accessory setting priority (accessory setting to be prioritized). In this embodiment, the accessory setting priority (setting priority mode) has a first accessory setting priority (first mode) and a second accessory setting priority (second mode). In the first accessory setting priority, the accessory setting (first set value) stored in the camera memory 107 of the camera body 100 is preferentially set as a set value for the accessory apparatus 300. On the other hand, in the second accessory setting priority, the accessory setting (second set value) stored in the accessory memory 305 of the accessory apparatus 300 is preferentially set as a set value for the accessory apparatus 300.

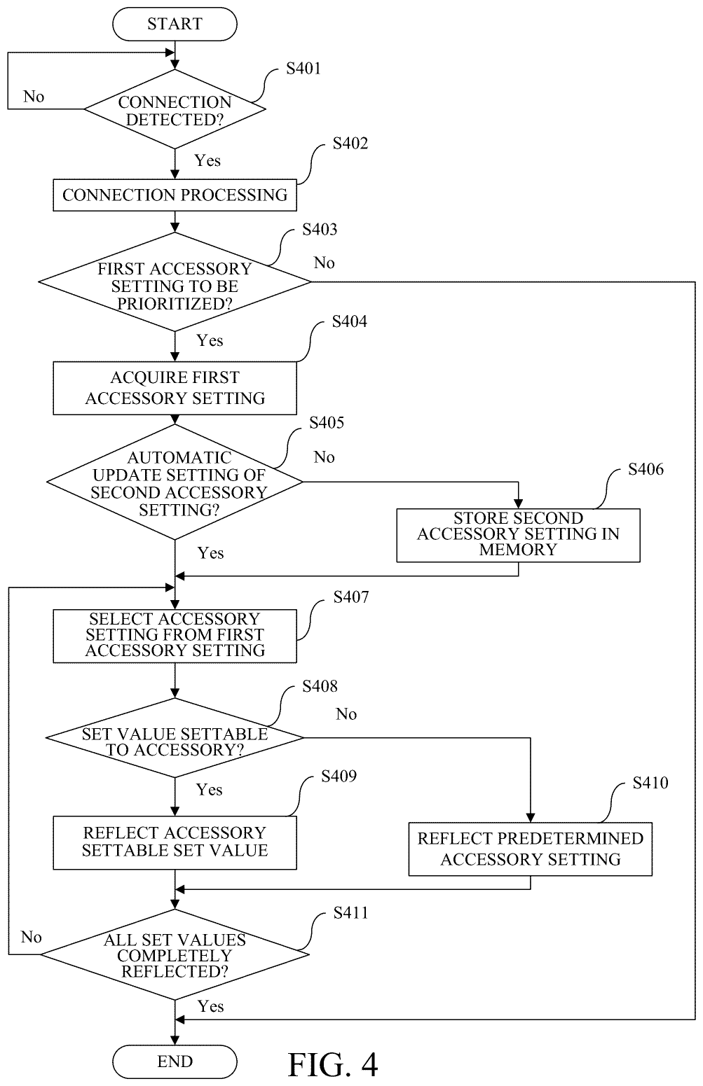

Referring now to FIG. 5, a description will be given of a setting screen for the accessory setting priority. FIG. 5 is an example setting screen for the accessory setting priority. As illustrated in (a) of FIG. 5, one of the camera body 100 and the accessory apparatus (flash) 300 can be set as the accessory setting priority. In (a) of FIG. 5A, the flash is set as the accessory setting priority. In this case, the second accessory setting is prioritized.

The user can switch between the first accessory setting priority and the second accessory setting priority by operating the accessory operation unit 303 to switch the setting of the accessory setting priority. In this embodiment, the accessory setting priority information is stored in the accessory apparatus 300, but this embodiment is not limited to this example. For example, the accessory setting priority information may be stored in the camera body 100 and the information may be notified via the accessory communication unit 108. Alternatively, the accessory setting priority information may be stored in the accessory apparatus 300, and a setting screen similar to that illustrated in FIG. 5 may be displayed on the camera body 100 to allow the user to set it, and the information may be notified to the accessory apparatus 300.

In a case where the first accessory setting priority is determined in step S403, the flow proceeds to step S404. On the other hand, in a case where the second accessory setting priority is determined, this flow ends.

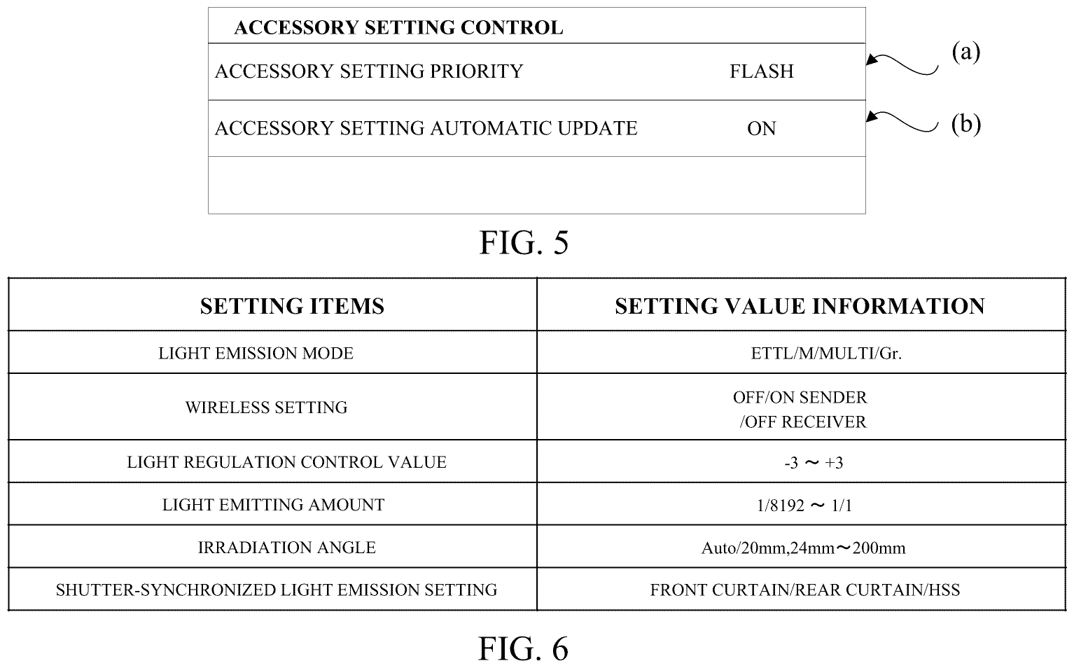

In step $404, the camera control unit 101 notifies the accessory apparatus 300 of the first accessory setting (first accessory setting information, first set value) stored in the camera body 100 via the accessory communication unit 108. Thereby, the accessory control unit 301 can acquire the first accessory setting information. FIG. 6 illustrates example setting items and set value information in the first accessory setting information. The camera control unit 101 selects set value information (set value) corresponding to the setting item illustrated in FIG. 6, and notifies the accessory apparatus 300 of the selected set value information.

In this embodiment, the setting items include, but are not limited to, the light emission mode, wireless setting, light regulation control value, light emitting amount, irradiation angle, and shutter-synchronized light emission setting. The setting items may include, for example, a custom function setting (not illustrated) that allows fine switchable settings for the accessory apparatus 300. The custom function setting includes a setting for whether to enable emission of the light emitter 302 that assists an autofocus (AF) function if it is difficult to focus on an object due to low illuminance in a case where the AF function of the camera body 100 is enabled. In addition, the set value information includes several pieces of set value information for each setting item, but is not limited to these examples.

Next, in step S405, the accessory control unit 301 determines whether the automatic update setting of the second accessory setting is enabled (whether the acquired first accessory setting is automatically updated as the second accessory setting). For example, the accessory setting unit (accessory operation unit 303, accessory display unit 304) sets whether the second accessory setting stored in the accessory memory 305 is automatically updated by user operation. In a case where the second accessory setting is set to be automatically updated, the flow proceeds to step S407. On the other hand, in a case where the second accessory setting is set not to be automatically updated, the flow proceeds to step S406.

Referring now to FIG. 5, a description will be given of an example setting screen for the automatic accessory update setting. As illustrated in (b) of FIG. 5, the user operates the accessory operation unit 303 to set the setting as “ON” or “OFF,” so that the first accessory setting priority or the second accessory setting priority can be automatically reflected. Similarly to the accessory setting priority illustrated in (a) of FIG. 5, the setting for automatic accessory setting update may be stored in the camera body 100.

In step S406, the accessory control unit 301 stores, in the accessory memory 305, the second accessory setting already set in the accessory apparatus 300. For example, in a case where the accessory control unit 301 is set to the first accessory setting, it changes the second accessory setting stored in the accessory memory 305 to the first accessory setting and stores the second accessory setting in the accessory memory 305 again. That is, in a case where the accessory control unit 301 is set to not automatically update the second accessory setting in step S405, it stores the second accessory setting in the accessory memory 305. Alternatively, the camera setting unit (camera operation unit 105, camera display unit 106) may set whether or not to automatically update the second accessory setting by user operation. In a case where it is determined that the second accessory setting is not to be automatically updated, the accessory control unit 301 stores the second accessory setting in the accessory memory 305 by communication with the camera body 100. Thereby, the user can reset the second accessory setting.

In step S407, the accessory control unit 301 selects an accessory setting (set value information) to be updated from the list of first accessory settings according to the user setting. The accessory control unit 301 performs update processing for each setting item in the selected set value information in the following steps S408 to S411.

In step S408, the accessory control unit 301 determines whether the accessory setting selected in step S407 is a set value that can be set in the accessory apparatus 300. In a case where the selected accessory setting is a settable set value, the flow proceeds to step S409. On the other hand, in a case where the selected accessory setting is not a settable set value, the flow proceeds to step S410.

In step S409, the accessory control unit 301 reflects the selected first accessory setting in the second accessory setting. Thereby, the accessory control unit 301 can control the accessory apparatus 300 based on the reflected first accessory setting.

In step S410, the accessory control unit 301 reflects the set value (predetermined accessory setting) settable to the accessory apparatus 300, to the second accessory setting. Here, as the predetermined accessory setting, the second accessory setting before reflection may be set as it is, or a predetermined set value (fixed set value) may be set to the second accessory setting.

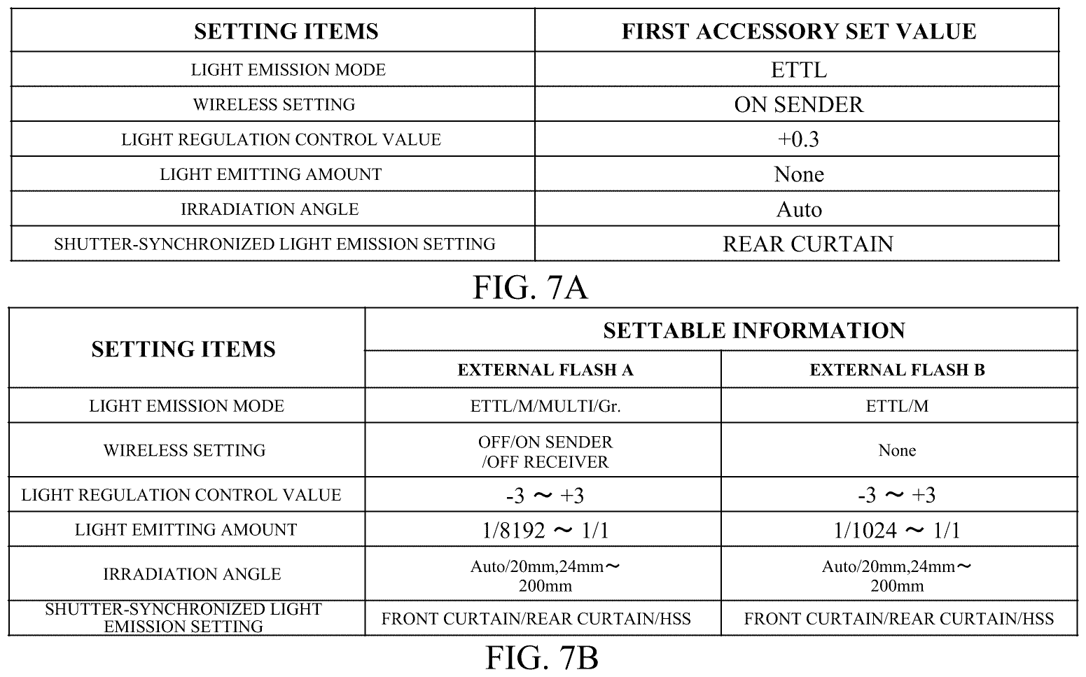

Referring now to FIGS. 7A and 7B, a specific description will be given of a situation in which an inconsistency occurs in the accessory set value. FIGS. 7A and 7B illustrate an example of a first accessory setting notified from the camera body 100 in a case where the accessory apparatus 300 is an external flash apparatus, and an example of settable information to the external flash apparatuses A and B. The external flash apparatus A in FIG. 7B is compatible with all of the first accessory set values in FIG. 7A, and all set values can be reflected in the second accessory setting. On the other hand, the external flash apparatus B in FIG. 7B has no wireless setting and cannot be set in a case where a light emitting amount is 1/1024 or less, so an inconsistency occurs. For example, by replacing the wireless setting with a non-wireless setting or clipping the light emitting amount to 1/1024, it can be used without inconsistency even in the case of an external flash apparatus B.

Next, in step S411 of FIG. 4, the camera control unit 101 or the accessory control unit 301 determines whether or not the reflection of all the first accessory settings (all set values) has been completed. In a case where the reflection of all the first accessory settings has been completed, this flow ends. On the other hand, in a case where the reflection of the first accessory settings has not yet been completed, the flow proceeds to step S407, and an unreflected first accessory setting is selected and the subsequent steps are repeated.

In this embodiment, the accessory control unit 301 can obtain the first set value for the accessory apparatus 300 stored in the camera body 100 by communicating with the camera body 100, and the accessory memory 305 stores the second set value for the accessory apparatus 300. The accessory control unit 301 also determines whether to preferentially use the first set value or the second set value as the set value for the accessory apparatus 300 according to the user setting. This determination may be made by the camera control unit 101 instead of the accessory control unit 301. Alternatively, the camera control unit 101 and the accessory control unit 301 may cooperate to make the determination.

In a case where the accessory control unit 301 determines that the accessory apparatus 300 and the camera body 100 are connected, it may determine whether the first accessory setting or the second accessory setting is to be used on a priority basis.

The accessory apparatus 300 may include an accessory setting unit (accessory operation unit 303, accessory display unit 304) configured to set whether the first set value or the second set value is to be used on a priority basis through a user operation. The accessory control unit 301 determines whether the first set value or the second set value is to be preferentially used according to the setting by the accessory setting unit.

Alternatively, the camera body 100 may include a camera setting unit (camera operation unit 105, camera display unit 106) configured to set whether the first set value or the second set value is to be preferentially used through a user operation. In this case, the accessory control unit 301 can determine whether to preferentially use the first set value or the second set value through communication with the camera body 100.

In a case where the accessory control unit 301 determines that the first set value is to be preferentially used and that the accessory apparatus 300 cannot set the first set value, the accessory control unit 301 may use a predetermined set value (the second set value or a fixed set value) settable to the accessory apparatus 300.

Even if a different accessory apparatus 300 is attached to the camera body 100, this embodiment can notify the accessory apparatus 300 of a consistent accessory setting, and resume imaging using the same setting. As a result, this embodiment can improve user convenience.

### Second Embodiment

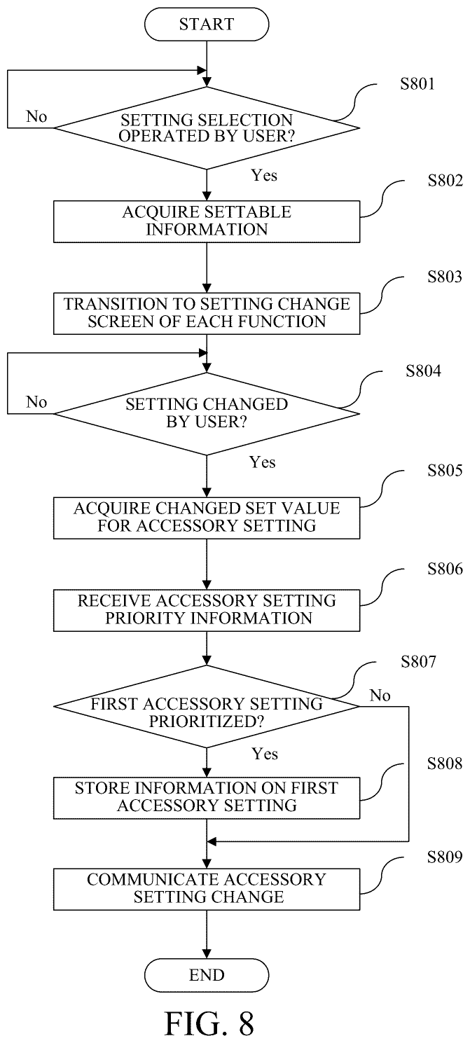

Referring now to FIG. 8, a description will be given of setting processing for the accessory apparatus 300 according to a second embodiment. FIG. 8 is a flowchart illustrating the setting processing of the accessory apparatus 300 according to this embodiment. Each step in FIG. 8 is mainly executed by the camera control unit 101 or the accessory control unit 301. This embodiment will discuss a method for updating an accessory set value stored in the camera body 100 in a case where a setting is updated from the accessory function setting screen on the camera display unit 106 in the camera body 100. This embodiment assumes that the camera body 100 and the accessory apparatus 300 are already attached and can communicate via the accessory communication unit 108.

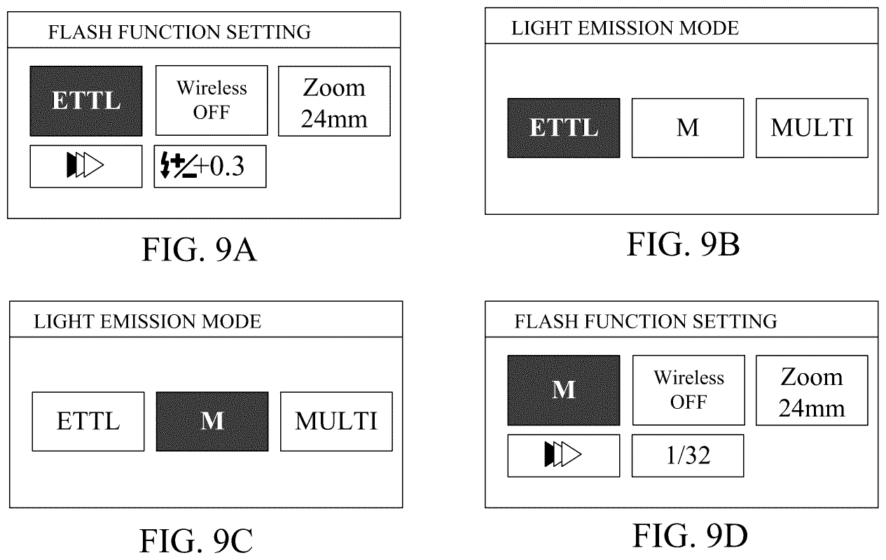

First, in step S801, the camera control unit 101 determines whether or not the user has performed an operation to select one of the accessory functions on the accessory function setting screen of the camera body 100. FIGS. 9A, 9B, 9C, and 9D illustrate example screen transitions of the accessory function setting screen displayed on the camera display unit 106 in a case where the accessory apparatus 300 is an external flash apparatus. In FIG. 9A, the item currently selected by a cursor is blacked out (in the display example of FIG. 9A, the light emission mode is selected by the cursor), and the cursor can be moved to another accessory function by operating the camera operation unit 105. Operating the operation member of the camera operation unit 105 that prompts the user to make a decision can transition to a setting change screen for the accessory function item currently selected by the cursor, and this operation is regarded as an operation for selecting one of the accessory functions.

In a case where it is determined in step S801 that an operation to select one of the accessory functions (a setting selection operated by the user) has been performed, the flow proceeds to step S802. On the other hand, in a case where it is determined that the setting selection operation has not been performed by the user, the flow returns to step S801, and the camera control unit 101 monitors whether an operation to select one of the accessory functions has been performed.

In step S802, the camera control unit 101 acquires the settable information for the accessory apparatus 300 via the accessory communication unit 108. For example, in the light emission mode of FIG. 7B, the external flash apparatus A can set the light emission modes ETTL/Manual/MULTI/Gr. On the other hand, the external flash apparatus B can set only two set values, ETTL/Manual. Displaying a setting screen on the camera display unit 106 of the camera body 100 according to the settable information for the accessory apparatus 300 to be attached can encourage the user to make settings without becoming confused.

Next, in step S803, the camera control unit 101 displays set values settable to the accessory apparatus 300 based on the setting availability information acquired in step S802 (transition to a setting change screen for each function). FIG. 9B is an example light emission mode selection screen to which the screen transitions in a case where a light emission mode is selected in FIG. 9A. In this selection screen, the user can operate the camera operation unit 105 to prompt the user to change the setting to the set value that he wishes to change.

Next, in step S804, the camera control unit 101 determines whether or not the set value has been changed by the user operation (whether or not there has been a setting change). In a case where it is determined that there has been a setting change, the flow proceeds to step S805. On the other hand, in a case where it is determined that there has been no setting change, the flow returns to step S804, and the camera control unit 101 monitors whether or not the set value has been changed. Operating the camera operation unit 105 as illustrated in FIG. 9D can move the cursor selection of the set value for the accessory function to be selected, and operating the operation member of the camera operation unit 105 that prompts the user to make a decision can transition to the processing of changing the set value in step S805 and subsequent steps.

In step S805, the camera control unit 101 acquires set value information changed based on the output of the camera operation unit 105 in step S804. For example, in a case where the camera operation unit 105 is operated to prompt a decision at the position illustrated in FIG. 9C, the light emission mode becomes the changed set value information as the manual mode, and the display of the light emission mode is changed to the manual mode as illustrated in FIG. 9D.

Next, in step S806, the camera control unit 101 acquires accessory setting priority information from the accessory apparatus 300 via the accessory communication unit 108. The accessory setting priority information is information indicating whether the first accessory setting (first set value) or the second accessory setting (second set value) is to be preferentially set.

Next, in step S807, the camera control unit 101 determines whether or not the accessory setting priority information acquired in step S806 indicates the first accessory setting priority. In a case where it is determined that the accessory setting priority information indicates the first accessory setting priority, the flow proceeds to step S808. On the other hand, in a case where it is determined that the accessory setting priority information does not indicate the first accessory setting, the flow proceeds to step S809.

In step S808, the camera control unit 101 stores the changed set value information acquired in step S805 in the camera memory 107, and the flow proceeds to step S809.

In step S809, the camera control unit 101 notifies the accessory apparatus 300 of the changed set value information acquired in step S805 via the accessory communication unit 108, and ends this flow. The accessory apparatus 300 updates the set value after it receives communication of the accessory setting change.

Even if the set value is changed from the accessory setting screen of the camera body 100, this embodiment can update the first accessory setting. Therefore, even if a different accessory apparatus 300 is attached, this embodiment can resume imaging while preventing the set value from being one unintended by the user.

### Third Embodiment

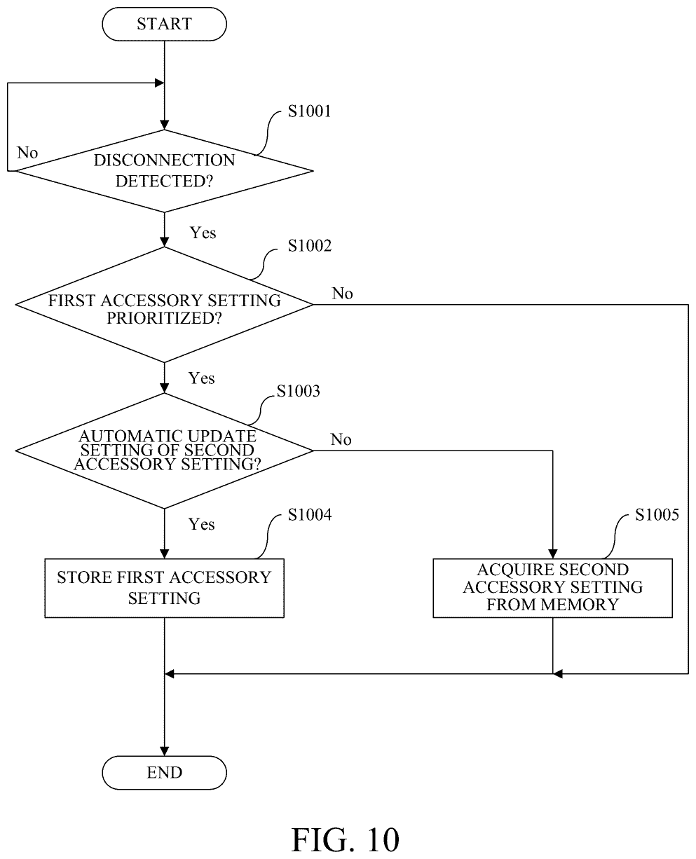

Referring now to FIG. 10, a description will be given of setting processing for the accessory apparatus 300 according to a third embodiment. FIG. 10 is a flowchart illustrating the setting processing for the accessory apparatus 300 according to this embodiment. Each step in FIG. 10 is mainly executed by the camera control unit 101 or the accessory control unit 301. This embodiment will discuss a method for updating the second accessory setting in a case where the accessory apparatus 300 and the camera body 100 are disconnected.

First, in step S1001, the accessory control unit 301 detects a change in the connection state with the camera body 100 and determines whether or not the accessory apparatus 300 and the camera body 100 are disconnected. A method for detecting a change in the connection state includes a method in which the user operates the accessory lock unit 307 from the lock position to the unlock position, and the disconnection is determined by detecting the output of the accessory connection detector 308 that has been changed by the operation. Another detecting method is a method in which the camera control unit 101 monitors the power supply state of the camera body 100, and in a case where the power is turned off, notifies the accessory control unit 301 of the camera power-off state via the camera startup status notification unit 109, and the accessory control unit 301 determines the disconnection based on the output. This embodiment assumes that both detecting methods are available, but may use only one of them or a different detecting method.

In a case where the accessory apparatus 300 and the camera body 100 are disconnected in step S1001 (in a case where it is determined that the accessory apparatus 300 has been detached from the camera body 100), the flow proceeds to step S1002. On the other hand, in a case where it is determined that the accessory apparatus 300 and the camera body 100 are not disconnected, the accessory control unit 301 repeats the determination in step S1001.

In step S1002, the accessory control unit 301 determines whether or not the set value for the accessory setting priority that is set in the accessory apparatus 300 is the first accessory setting priority. In a case where it is determined in step S1002 that the first accessory setting is a setting to be prioritized, the flow proceeds to step S1003. On the other hand, in a case where the set value for the accessory setting priority is not the first accessory setting (first set value), that is, in a case where the second accessory setting (second set value) is a setting to be prioritized, the flow ends. In a case where the first accessory setting is a setting to be prioritized in step S1002, the first accessory setting is set to the accessory apparatus 300.

In step S1003, the accessory control unit 301 determines whether or not the second accessory setting set to the accessory apparatus 300 is a setting to be automatically updated. In a case where the second accessory setting is a setting to be automatically updated, the flow proceeds to step S1004. On the other hand, in a case where the second accessory setting is not a setting to be automatically updated, the flow proceeds to step S1005.

In step S1004, the accessory control unit 301 stores the first accessory setting in the accessory memory 305. At this time, the first accessory setting is set to the accessory apparatus 300. Storing the first accessory setting in the accessory memory 305 again can continue using the setting as the second accessory setting even if the accessory apparatus 300 is powered off.

In step S1005, the accessory control unit 301 acquires the second accessory setting previously stored in the accessory memory 305, and reflects the second accessory setting in the setting of the accessory apparatus 300. Thereby, the accessory control unit 301 can change the setting from the first accessory setting to the second accessory setting.

In this embodiment, in a case where the accessory apparatus 300 and the camera body 100 are disconnected while the first accessory setting is set, the accessory control unit 301 changes the set value for the accessory apparatus 300 from the first accessory setting to the second accessory setting.

In a case where the accessory apparatus 300 is detached from the camera body 100, this embodiment can reflect, to the accessory apparatus 300, the second accessory setting before attachment to the camera body 100. Even after the accessory apparatus 300 is detached, the accessory apparatus 300 can be used while the first accessory setting is maintained.

In a case where an accessory apparatus is detached and another accessory apparatus is attached, each embodiment can resume imaging using the same settings for the previous accessory apparatus without resetting the individual accessory functions. Also, imaging can be resumed using the set values set to each accessory apparatus. Therefore, each embodiment can provide an accessory apparatus, an image pickup apparatus, a control method, and a storage medium, each of which can improve user convenience.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-016230, which was filed on Feb. 6, 2024, and which is hereby incorporated by reference herein in its entirety.

What is claimed is:

1. An accessory apparatus attachable to and detachable from an image pickup apparatus, the accessory apparatus comprising:
an accessory processor configured to acquire a first set value for the accessory apparatus stored in the image pickup apparatus through communication with the image pickup apparatus; and
an accessory memory storing a second set value for the accessory apparatus,
wherein the accessory processor is configured to determine whether to preferentially use the first set value or the second set value as a set value for the accessory apparatus according to a user setting.

2. The accessory apparatus according to claim 1, further comprising an accessory setting unit configured to perform a setting regarding whether to preferentially use the first set value or the second set value according to a user operation,
wherein the accessory processor is configured to determine whether to preferentially use the first set value or the second set value according to the setting by the accessory setting unit.

3. The accessory apparatus according to claim 1, wherein the accessory processor is configured to determine whether to preferentially use the first set value or the second set value through the communication with the image pickup apparatus that includes a camera setting unit configured to set whether to preferentially use the first set value or the second set value through a user operation.

4. The accessory apparatus according to claim 1, wherein the accessory processor is configured to use a predetermined set value settable to the accessory apparatus, in a case where the accessory processor has determined that the first set value is to be preferentially used and the accessory apparatus cannot set the first set value.

5. The accessory apparatus according to claim 4, wherein the predetermined set value is the second set value or a fixed set value.

6. The accessory apparatus according to claim 1, wherein in a case where the accessory processor sets the first set value, the accessory processor is configured to change the second set value stored in the accessory memory to the first set value and stores the second set value again in the accessory memory.

7. The accessory apparatus according to claim 6, further comprising an accessory setting unit configured to set whether or not to automatically update the second set value stored in the accessory memory by a user operation,
wherein the accessory processor is configured to store the second set value in the accessory memory in a case where the second set value is set not to be automatically updated.

8. The accessory apparatus according to claim 6, wherein the accessory processor is configured to store the second set value in the accessory memory in a case where the accessory processor determines that the second set value is not to be automatically updated through the communication with the image pickup apparatus that includes a camera setting unit configured to set whether or not to automatically update the second set value stored in the accessory memory by a user operation.

9. The accessory apparatus according to claim 1, wherein the accessory processor is configured to determine whether or not to preferentially use the first set value or the second set value in a case where the accessory processor determines that the accessory apparatus and the image pickup apparatus are connected.

10. The accessory apparatus according to claim 1, wherein in a case where the accessory processor determines that the accessory apparatus and the image pickup apparatus are disconnected while the first set value is set, the accessory processor is configured to change the set value for the accessory apparatus from the first set value to the second set value.

11. The accessory apparatus according to claim 1, wherein the set value includes a value regarding at least one of a light emission mode, a wireless setting, a light regulation control value, a light emitting amount, an irradiation angle, a shutter-synchronized light emission setting, and a custom function setting for the accessory apparatus.

12. The accessory apparatus according to claim 1, wherein the accessory apparatus is an illumination apparatus.

13. An image pickup apparatus attachable to and detachable from an accessory apparatus, the image pickup apparatus comprising:
a camera memory storing a first set value for the accessory apparatus; and
a camera processor configured to:
transmit the first set value to the accessory apparatus through communication with the accessory apparatus, and
determine whether to preferentially use the first set value or a second set value stored in the accessory apparatus as a set value for the accessory apparatus according to a user setting.

14. The image pickup apparatus according to claim 13, wherein in a case where the first set value is changed by a user operation in a setting in which the first set value is to be preferentially used, the camera processor is configured to store the first set value that has been changed, in the camera memory.

15. A control method for an accessory apparatus attachable to and detachable from an image pickup apparatus, the control method comprising the steps of:
determining whether to preferentially use a first set value stored in the image pickup apparatus or a second set value stored in the accessory apparatus as a set value for the accessory apparatus according to a user setting;
acquiring the first set value through communication with the image pickup apparatus in a case where it is determined that the first set value is to be used; and
setting the first set value as the set value for the accessory apparatus.

16. A control method for an image pickup apparatus attachable to and detachable from an accessory apparatus, the control method comprising the steps of:
determining whether to preferentially use a first set value stored in the image pickup apparatus or a second set value stored in the accessory apparatus as a set value for the accessory apparatus according to a user setting; and
transmitting the first set value through communication with the accessory apparatus in a case where it is determined that the first set value is to be used.

17. A non-transitory computer-readable storage medium storing a program that causes a computer to execute the control method according to claim 15.

18. A non-transitory computer-readable storage medium storing a program that causes a computer to execute the control method according to claim 16.
